(19) United States
(12) Patent Application Publication
(10) Pub. No.: US 2002/0163976 A1
(43) Pub. Date: Nov. 7, 2002

(54) Method for transmitting data

(75) Inventor: Udo Karthaus, Heilbronn (DE)

Correspondence Address: FASSE PATENT ATTORNEYS, P.A., P.O. BOX 726, HAMPDEN, ME, 04444-0726, US

(73) Assignee: ATMEL Germany GmbH, Heilbronn (DE)

(21) Appl. No.: 10/132,956

(22) Filed: Apr. 26, 2002

(30) Foreign Application Priority Data
May 4, 2001 (DE) 101 21 855.9

(51) Int. Cl. H04L 27/04

(52) U.S. Cl. 375/295; 375/300; 375/303

(57) ABSTRACT

In the known methods for transmitting data, the voltage of the modulation signal changes a plurality of times within one bit, or the voltage value of the modulation signal is determined by the significance of the bit.

In the new method, the voltage of the modulation signal changes from bit to bit irrespective of the type of modulation. The data rate is thus substantially increased in the case of an amplitude modulated carrier wave. Moreover, a data clock, which can replace internal clock generation, for example in the case of passive transponders, can be derived from the modulated carrier wave in a simple manner. The reduction of the power consumption increases the communication range of the transponder, especially when using carrier waves in the microwave range.

### BACKGROUND

1. Field of the Invention

The present invention relates to a method for transmitting data between a base station and a transponder according to the preamble of patent claim 1.

2. Description of the Related Technology

Such a method is known from the publication EP 473 569 B1. In this connection, digital data is exchanged between a base station and a passive transponder by means of an amplitude modulated carrier wave. The individual bits of a data word consist of a period of time during which the electromagnetic field is switched on and a period of time during which the electromagnetic field is switched off (field gap), whereby the field gap acts as a separator between two successive bits. The significance of the bits is determined by the length of time for which the electromagnetic field is switched on. The fixed temporal length of the field gap is included in the total time of the representation of the individual bits. Moreover, in the case of the passive system, the energy is generated from the carrier field by means of absorption modulation, and the system clock for the transponder is generated from the frequency of the electromagnetic wave.

Moreover, further methods are described in the data book of TEMIC Semiconductor GmbH, 1999, p. 321 and p. 337, by means of which digital information in the form of data words is coded on an electromagnetic carrier wave. In the case of phase and frequency modulation, the carrier wave is modulated by means of a defined assignment of voltage values which is a function of the significance of the individual bits. The voltage curve of the modulation signal is thus determined by the sequence of the significance of the individual bits. In general, methods for transmitting data with transponders are utilized to perform an identification within a so-called authentication process. Particularly in applications in the automotive field, the authentication process between base station and transponder must be completed within a period of about 100 ms so that the user does not notice any delay. In order to achieve this, a multitude of data words have to be transmitted in short periods of time by means of a carrier wave. Amplitude modulation is primarily used for this purpose, apart from phase and frequency modulation. In the case of an authentication process, the data rate has to be further increased in order to implement the ever increasing security requirements. As carrier frequencies in the UHF and microwave ranges generally also have greater bandwidths, these high carrier frequencies are increasingly being used in the transponder field. Generating the clock by means of frequency division from the very high-frequency carrier wave cannot be achieved with a reasonable expenditure, especially in the case of passive transponders which do not have their own power supply. Moreover, demodulation in the microwave range and the generation of a system clock, for example by means of an oscillator circuit, require a lot of energy which has to be obtained from the carrier field by absorption modulation. The range of communication between the base station and the passive transponder is consequently restricted to a few cm.

The disadvantage of the previous methods is that the bandwidth of the respective carrier frequency in the case of the particularly frequently used amplitude modulation is inadequately exploited, that is the actual data rate is significantly less than the maximum possible data rate. This becomes distractingly obvious in time-critical applications. Moreover, the previous methods are only able to achieve a very short range of communication with phase and frequency modulation.

### SUMMARY OF THE INVENTION

The object of the present invention is to provide a method for transmitting data which increases the data rate for wireless communication, and with which a system clock can be generated in the case of passive transponders in an energy-efficient manner even with high carrier frequencies. This object of the invention is solved by a method of the type mentioned at the beginning, with the features of patent claim 1. Favorable embodiments are the objects of subclaims.

Accordingly, the essence of the invention consists, in the case of non-contact communication between a base station and a transponder, of combining a modulation signal, that consists of a sequence of at least two different voltage values, with a data word, that consists of a sequence of individual bits, in order to modulate an electromagnetic carrier wave. For this purpose, each bit position within the data word is successively assigned a voltage value from the different successive voltage values, in which the significance of the individual data bit determines the temporal length of the respective voltage value. In contrast to the previous methods, the voltage value of the modulation signal changes on each occasion between adjacent bit positions. The data rate is substantially increased, especially in the case of an amplitude modulated carrier wave. As the modulation of the carrier wave is changed with each bit change, a data clock, and from that a system clock, can be generated from the demodulation of the carrier wave.

In an advantageous development of the method, the carrier wave is modulated with a defined, repeating sequence of different voltage values. Provided that it is intended to achieve a large modulation amplitude, for example in the case of difficult receiving conditions, it is advantageous to use a modulation signal that consists of a sequence of two voltage values, which create a maximum permissible modulation amplitude in the carrier wave, and to adapt the temporal length of the individual voltage values of the modulation signal.

Investigations by the applicant have shown that amplitude modulation, phase modulation or frequency modulation can be performed with a modulation signal on a carrier wave with the method according to the invention.

As regards amplitude modulation, the advantage over the previous state of the art is that, in contrast to the previous methods for data transmission by means of a carrier wave, one single bit of a data word in the modulation signal is assigned at least two voltage values, and the second voltage value is assigned its own bit, this second voltage value is normally zero and is essential as a separator between two successive bits. In this case it is irrelevant whether a lower value or a higher value bit follows in the bit sequence within the data word. Consequently, as the times of the field gaps, which were previously added to the field times of each bit, are used in a supplementary manner for information transmission, the data rate is substantially increased in the case of an amplitude modulated carrier frequency . Moreover, the temporal length of the field gap can be selected within the limits set by the transmission standards used and the technical capabilities of the transmitter and receiver systems. This is a substantial advantage, particularly in the case of time-critical applications in which access to an automotive vehicle is controlled by means of an authentication process. Moreover, the increase in the data rate does not depend upon either the number of different modulation signal voltage values selected or the selected sequence of voltage values, or the frequency of the carrier wave, and also applies to carrier frequencies in the microwave range. When a phase and frequency modulation is performed with a modulation signal according to the invention, the phase or the frequency of the carrier wave changes, in contrast to the previous methods, with each bit irrespective of its significance. Rather, the significance exclusively determines the temporal length of the respective modulation state and can also be changed or arranged during the data transmission, for example by means of a so-called “header information”, such as is usual at the beginning of a sequence of data words.

In another development of the method, the lower value bit is assigned a shorter temporal length than the higher value bit. In so doing, it is particularly advantageous when the lower value bit has half the length of the higher value bit.

A further advantage of the method according to the invention is that a pulse occurs with each bit change as a result of the voltage values in the modulation signal changing with each bit, i.e. from the determination of the amount of derivation from the modulated carrier wave, a data clock can be derived from this pulse. It is also possible to generate a system clock from the data clock in order to take the place of a major circuit component. The lower power consumption substantially increases the communication range of the passive transponder to the base station.

### BRIEF DESCRIPTION OF THE FIGURES

The method according to the invention is described in the following by means of the embodiments in conjunction with the drawings. They show:

FIG. 1 A modulation signal with a bit-by-bit change of voltage values, and

FIG. 2a An amplitude modulated carrier wave generated by the modulation signal shown in FIG. 1, and

FIG. 2b A data clock signal which is derived from the carrier wave shown in FIG. 2a, and

FIG. 3a A frequency modulated carrier wave generated by the modulation signal shown in FIG. 1, and

FIG. 3b A data clock signal which is derived from the carrier wave shown in FIG. 3a, and

FIG. 4 A modulation signal for pulse width modulation according to the previous state of the art.

### DESCRIPTION OF THE PREFERRED EMBODIMENTS

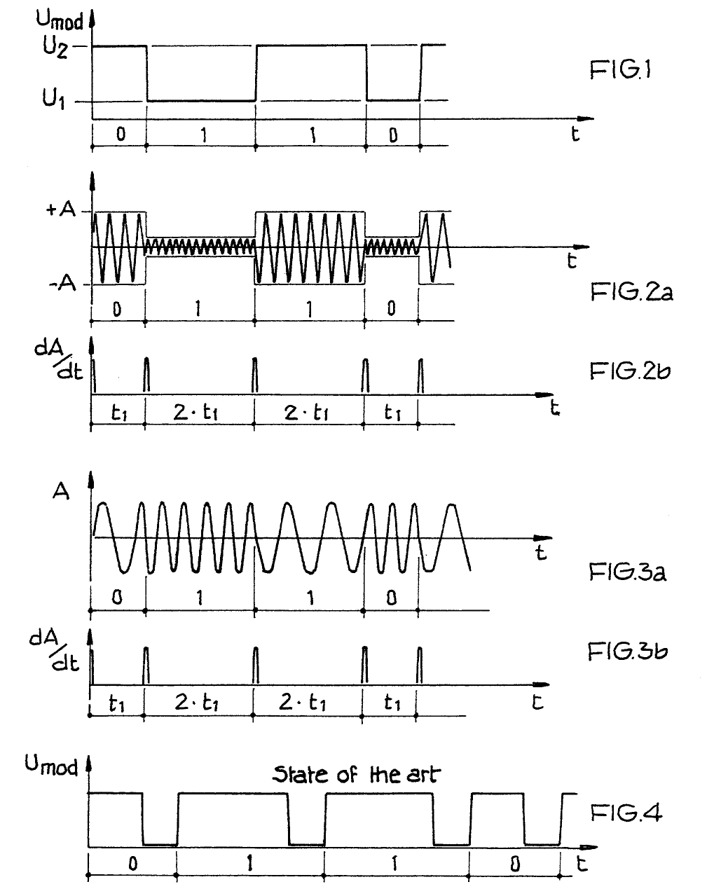

FIG. 4 shows a modulation signal according to the previous state of the art with which, in the case of an electromagnetic carrier wave (not shown), a pulse width modulation is performed in order to transmit, for example, digital data for an identification between a base station and a transponder. For this, the value of the modulation voltage is shown against time in the illustration. The structure of the modulation signal, which alternates between two voltage values, is explained in the following. The modulation signal shows a sequence of a digital data word, which consists of a sequence of lower value and higher value bits. The voltage amplitude of the modulation signal changes within one bit from the voltage value Umod to the voltage value zero, whereby the higher value bit is assigned a substantially longer period of time, during which the modulation voltage assumes the value Umod, than the lower value bit. This is followed by a further period of time for both significances of the bits, which is independent of the significance of the respective bit, during which the modulation voltage assumes the value zero. A carrier wave is not emitted during the times in which the modulation voltage has the value zero. Such times are termed field gaps, and serve to separate the individual bits of a data word. A modulation signal according to the method of the invention is shown in FIG. 1. As in FIG. 4, the temporal course of the modulation voltage is shown, in which the same sequence of lower value and higher value bits has been selected. The structure of the modulation signal, which alternates between two voltage values U2 and U1, is explained in the following. In contrast to the previous state of the art, the voltage value of the modulation signal no longer changes within a bit but from one bit to the next bit. The change in the voltage is used to separate the bits and is independent of the sequence and significance of the bits, whereby in each case the lower value bit is assigned half the period of that time assigned to the higher value bit, during which the modulation signal retains the prevailing voltage. A significant advantage of the new modulation method is that a substantially shorter time is required to transmit a given bit sequence. The length of the period of time can be freely assigned to the significance of the bits provided that this has not been specified by a standardization of the communication between base station and transponder, whereby the length and difference between the periods of time between the higher-value bit and the lower-value bit can be set for the conditions of the complete base station and transponder system. The relevant settings are also transmitted in a “header information” which precedes the individual data sequences. FIG. 2a shows an amplitude modulation of a carrier wave based on the modulation signal shown in FIG. 1. The magnitude of the amplitude is shown against time. The short periods of time, during which the field is switched on or has a gap, are associated with the lower value bit (zero) in accordance with the assignment defined by the modulation signal. FIG. 2b shows the amount derived from the amplitude of the carrier wave shown in FIG. 2a against time. According to this, a delta-shaped signal is generated with every change of amplitude, in which, according to the assignment given in FIG. 1, the period of time t1 is correlated with the lower value bit, and the period of time 2t1 is correlated with the higher value bit. As a signal pulse precedes each new bit that is received, a data clock can be gained in a simple manner, and the significance of the bits can be determined by measuring the period of time between two successive pulses. The period of time can be measured by, for example, counting clock pulses, by comparing the number of clock pulses with a defined value. The communication between the transponder and a base station can be synchronized in a simple manner by deriving a data clock from the carrier wave. Moreover, a system clock can be derived from the data clock. This substantially reduces the energy consumption at carrier frequencies in the microwave range and considerably increases the communication range, particularly in the case of passive transponders without their own power supply.

FIG. 3a shows a frequency modulation of a carrier wave based on the modulation signal shown in FIG. 1. The magnitude of the amplitude is shown against time. The lower value bit is linked with the shorter period of time in accordance with the defined assignment, whereby the carrier wave has both a lower and a higher frequency.

FIG. 3b shows the amount derived from the frequency of the carrier wave shown in FIG. 3a against time. According to this, a delta-shaped signal is generated with every change of frequency, in which, according to the defined assignment, the period of time t1 is correlated with the lower value bit, and the period of time 2t1 is correlated with the higher value bit. As each bit received is preceded by a signal pulse, a data clock can be gained in a simple manner, and the significance of the bits can be determined by measuring the period of time between two successive pulses, and a system clock can be derived from the data clock, even in the case of a frequency modulated carrier wave. The reduction of the power consumption enables even frequency modulated carrier frequencies in the microwave range to be used for communication between a base station and a passive transponder.

What is claimed is:

1. Method for transmitting data between a base station and a transponder by means of a modulation signal, that consists of at least two different voltage values (U1, U2), for modulating an electromagnetic carrier wave with a data word which consists of a sequence of data bits,
wherein
each bit position of the data word is successively assigned a voltage value (U1, U2) of the modulation signal with different values on adjacent bit positions, and the significance of the individual data bit determines the temporal length of the voltage value (U1, U2).

2. Method according to claim 1, wherein the modulation of the carrier wave is performed with a defined, repeating sequence of voltage values (U1, U2) of the modulation signal.

3. Method according to claim 1, wherein the modulation of the carrier wave is performed with a modulation signal that has two voltage values (U1, U2).

4. Method according to claim 2, wherein the modulation of the carrier wave is performed with a modulation signal that has two voltage values (U1, U2).

5. Method according to claim 1, wherein an amplitude modulation (ASK) of the carrier wave is performed by means of the modulation signal.

6. Method according to claim 4, wherein an amplitude modulation (ASK) of the carrier wave is performed by means of the modulation signal.

7. Method according to claim 1, wherein a phase modulation (PSK) of the carrier wave is performed by means of the modulation signal.

8. Method according to claim 4, wherein a phase modulation (PSK) of the carrier wave is performed by means of the modulation signal.

9. Method according to claim 1, wherein a frequency modulation (FSK) of the carrier wave is performed by means of the modulation signal.

10. Method according to claim 4, wherein a frequency modulation (FSK) of the carrier wave is performed by means of the modulation signal.

11. Method according to claim 1, wherein a shorter temporal length is assigned to the lower value bits in comparison to the higher value bits.

12. Method according to claim 6, wherein a shorter temporal length is assigned to the lower value bits in comparison to the higher value bits.

13. Method according to claim 8, wherein a shorter temporal length is assigned to the lower value bits in comparison to the higher value bits.

14. Method according to claim 10, wherein a shorter temporal length is assigned to the lower value bits in comparison to the higher value bits.

15. Method according to claim 12, wherein, in the case of a digital data word, half the length (t1) of the higher value bit is assigned to the lower value bit.

16. Method according to claim 1, wherein a data clock is derived from the modulated carrier wave in order to determine the temporal length of the data bits.

17. Method according to claim 15, wherein a data clock is derived from the modulated carrier wave in order to determine the temporal length of the data bits.

18. Method according to claim 17, wherein a system clock is derived from the data clock.
